(19) United States
(12) Patent Application Publication
(10) Pub. No.: US 2004/0179021 A1
(43) Pub. Date: Sep. 16, 2004

(54) Method of displaying device test data

(76) Inventor: Paul J. Dickinson, San Jose, CA (US)

Correspondence Address: B. Noel Kivlin, Meyertons, Hood, Kivlin,, Kowert & Goetzel, P.C., P.O. Box 398, Austin, TX, 78767, US

(21) Appl. No.: 10/386,598

(22) Filed: Mar. 11, 2003

(51) Int. Cl. G09G 5/02

(52) U.S. Cl. 345/589

(57) ABSTRACT

A method of displaying a device test file including a plurality of bits includes receiving the test file and generating a graphic image representative of the test file by depicting each of the plurality of bits using a unique pixel of a display.

### BACKGROUND OF THE INVENTION

1. Field of the Invention

This invention relates to circuit testing and, more particularly, to the displaying of test patterns.

2. Description of the Related Art

Circuits are typically tested using an assortment of tests. Tests may be performed on a device by applying external stimuli to a device's inputs under a given set of conditions on a circuit tester and comparing the actual results to a given set of expected results. For example, in FIG. 1, a perspective view diagram of one embodiment of a device tester 10 is shown. Device tester 10 includes a CPU cabinet 100A which is coupled to a device tester component interface 100B via an interface cable 152. Further, device tester 10 includes a user interface 150 coupled to CPU cabinet 100A via an interface cable 151. A device-under-test (DUT) 110 is coupled to device tester component interface 100B using one of a variety of methods and hardware (not shown). The stimuli and the expected results are typically applied to DUT 110 using a test file which is commonly referred to as a test pattern.

Generally, a device test program and the test pattern are loaded into the tester memory (not shown). The test program may include software instructions written in any of a variety of programming languages, including some tester specific languages. The test program is executed by the tester CPU (not shown) and in conjunction with the test pattern a test environment may be created for the DUT. A user may control and monitor the testing process through user interface 150. Further, the user may view and edit the test patterns as well as analyze the test results through user interface 150. In addition, test program and test pattern files may be viewed and edited on a variety of other types of computer systems such as a network workstation or a desktop personal computer, for example.

One type of testing method that is commonly used to test integrated circuits is functional testing. During functional testing, DUT 110 is allowed to operate in one or more of its operating (i.e. functional) modes while the outputs are monitored and compared against a given set of expected results. Depending on the level of complexity of the circuit, functional testing may be an adequate testing method by itself.

However, due to such factors as increased device complexity, gate counts and test pin count constraints it has become more difficult to test a device adequately using only functional testing. In addition, creating large numbers of functional test patterns and then grading those patterns on commercial pattern grading tools can be an exhaustive task that may take many hours of computer time. Further, on many complex circuits, functional test patterns may routinely provide test coverage in the mid 80 percent range, while for many applications test coverage in the mid 90 percent range may be minimally acceptable. Thus another type of testing has become widely used: scan-based testing. Using rigorous design-for-testability techniques and automated test pattern generation (ATPG) tools, scan-based testing has been shown to routinely produce test patterns having test coverage in the upper 90 percent range.

Scan testing typically involves using one or more scan chains. A scan chain is created using scannable elements such as flip-flops that are part of the circuit, although other clocked storage devices may be used. The output of a given flip-flop is coupled to the input of another flip-flop. A large number of flip-flops may be connected in this manner, forming a scan chain that passes through the internal logic of the circuit. The scan chain may be thought of as a serial shift register, in which values are shifted from one register flop to the next. Using this method, multiple scan chains may be formed in a given integrated circuit.

To test a circuit using one type of scan chain, a scan test pattern, which is sometimes referred to as scan data or a test vector, is shifted or clocked into the scan chain using a scan clock in a scan mode, thereby loading each element of the scan chain with a predetermined value. For example, a scan chain containing 50 scan elements will be loaded with 50 predetermined values using 50 scan clock cycles. Following the initial loading, the circuit is then reverted to its normal operating mode. The circuit may then be clocked once with the system clock, allowing the predetermined values to propagate through the individual logic circuits connected to the scan elements. After allowing the circuits a sufficient time to respond, the scan data that is now contained in the scan elements is shifted out of the scan chain using the scan clock in the scan mode. The scan out data is compared with expected results to determine whether the circuit is faulty.

In a typical scan input pattern, logic ones and zeros are clocked into the scan chain. The scan output pattern contains the expected results. The results typically include a logic one, a logic zero or in some cases a “don't care” condition. These logic values are typically represented as different pattern symbols such as ASCII characters. Depending upon the type of tester used, the pattern symbols in the scan input and scan output patterns may be ones and zeros, or the letters ‘H’, ‘L’ and ‘X’ which represent a logic one, a logic zero and a don't care, respectively.

Referring to FIG. 2, an example of a scan pattern is shown. The scan pattern includes a scan input pattern and a scan output pattern. The top portion of the pattern is a scan input pattern and contains 912 scan input values. The bottom portion is a scan output pattern and contains 912 scan output values. The scan input pattern is depicted using ‘H’ and ‘L’ ASCII characters which represent logic values 1 and 0, respectively. The scan output pattern is shown using 1's and 0's which represent logic values 1 and 0, respectively. In addition, the ASCII character ‘M’ is used to represent a “don't care” value. In many cases, the ATPG tool may not be capable of generating an expected value of 1 or 0 for a given scan input value. Thus, the ATPG tool may place a “don't care” in the respective location in the scan output pattern. A don't care value may be a value or character used as a placeholder for a given bit in a test pattern.

Many scan chains contain as many as 100,000 flip-flops, and accordingly each scan pattern may have 100,000 corresponding ones and zeros, and 100,000 H, L, and X symbols. Typically, after an ATPG tool generates a test pattern it must be verified for accuracy. In addition, after a device has been tested, failing units may be analyzed to determine the cause of the failure. In either case, a human must view the scan pattern or the results of a device test. The scan patterns may not only be difficult to look at, but it may be difficult to discern information in the context of a complete scan chain.

### SUMMARY OF THE INVENTION

Various embodiments of a method of displaying device test data are disclosed. In one embodiment, a method of displaying a device test file including a plurality of bits may include receiving the test file and generating a graphic image representative of the test file by depicting each of the plurality of bits using a unique pixel of a display.

### BRIEF DESCRIPTION OF THE DRAWINGS

FIG. 1 is a perspective view diagram of one embodiment of a device tester.

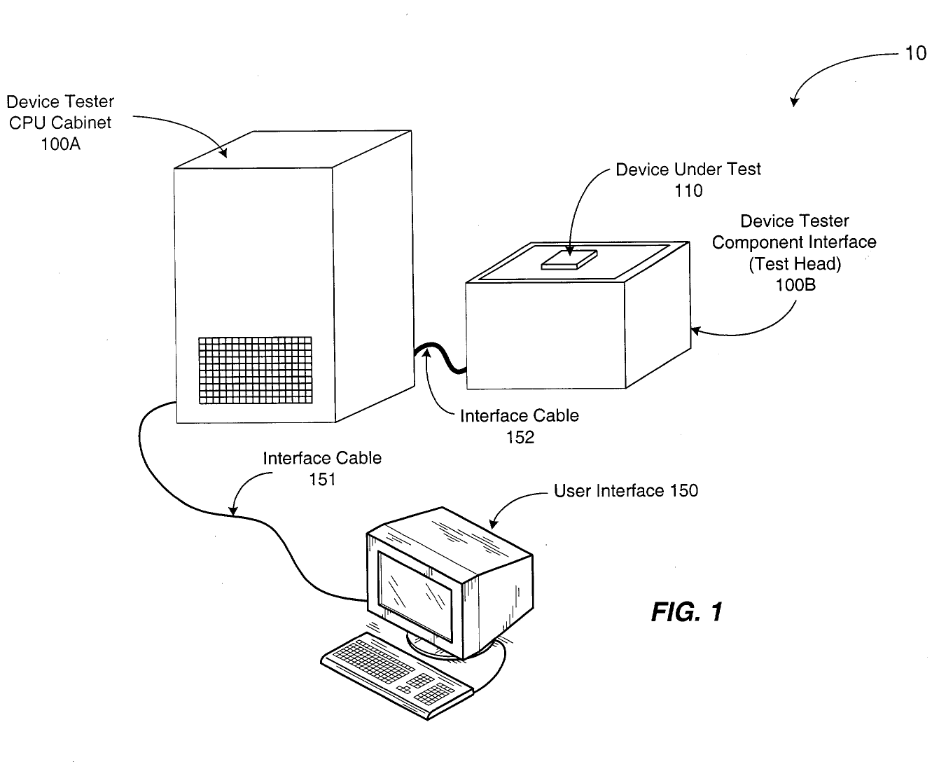

FIG. 2 is a diagram illustrating an example of a scan input and a scan output pattern.

FIG. 3 is a diagram of a display screen illustrating of one embodiment a pixel orientation.

FIG. 4 is a flow diagram describing one embodiment of a method of displaying device test data.

FIG. 5 is a diagram of one embodiment of an image corresponding to test pattern data.

FIG. 6 is a diagram of one embodiment of an image corresponding to test result data.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

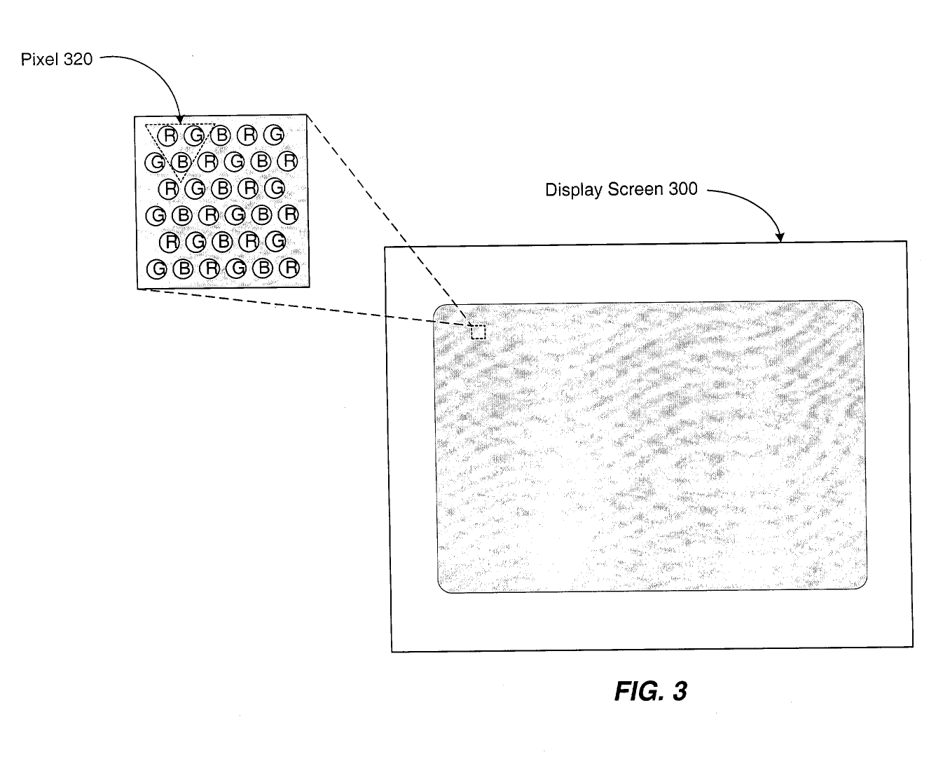

Turning now to FIG. 3, a diagram of a display screen illustrating one embodiment of a pixel orientation is shown. Display screen 300 is an example of the front viewing area of a display such as a cathode ray tube (CRT) display or a liquid crystal display (LCD). In the illustrated embodiment, display screen 300 is composed of many picture elements or “pixels.” In most displays, a pixel is the smallest portion of the display screen that may be individually controlled. In the exploded view, a pixel 320 is shown as a dot trio including a red, green and blue dot which are enclosed by the dashed triangle. However, it is noted that although the illustrated pixel dots are circular and the trio is arranged in the shape of a triangle, in other embodiments, a pixel may be formed by dots having other shapes and the dot trio may be arranged differently.

To display an image on display screen 300, the pixels may be illuminated and depending on the type of display, each pixel may be illuminated differently. For example, in a CRT, the individual dots may be phosphor dots which are selectively struck by electrons causing them to glow. On the other hand, an LCD pixel may be illuminated by backlighting the LCD panel using a fluorescent light element and filtering the light using polarizing active filters (e.g. liquid crystals). Each pixel may be illuminated to a different color and intensity.

In either type of display, the pixel count may range from as many as 1.9 million pixels to 480 thousand pixels depending on the resolution and size of a particular display. For example, some displays have a resolution of 1600×1200 pixels, while others may have as few as 800×600 pixels or fewer.

Thus, as will be described in greater detail below, representing a piece of data using a unique pixel may allow large amounts of certain types of data to be displayed on display screen 300 at a given time.

To create an image on display screen 300, a graphics adapter is typically used. Generally speaking, a graphics adapter may include a graphics processor and a random access memory digital-to-analog converter (RAMDAC). In addition, the graphics adapter may include some type of memory. The graphics adapter may process digital image data created either by a system processor or by the graphics processor and convert the digital image data into analog signals which may be displayed. For a CRT, the RAMDAC may provide the red, green and blue signals to the display, while for an LCD or other digital display, the digital signals may be sent to the display directly.

As described above, many graphics images are generated by a graphics adapter. Since many images are complex to generate, software packages including software drivers generally control how the images are created by the graphics adapter. Some software packages may read an image file which has been generated and saved and that defines the image. There are many commercially available file formats such as the joint photographic experts group (JPEG), graphics interchange format (GIF), tagged image file format (TIFF), for example which may be used to create, save and display a graphics image. An image saved in one of these or other graphics file formats may be read and displayed.

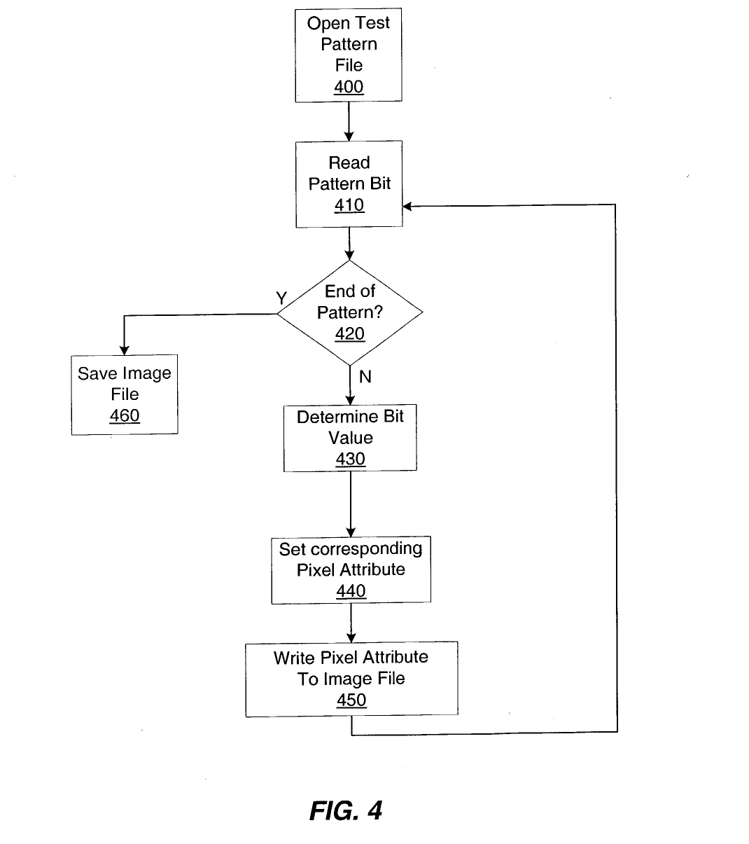

FIG. 4 illustrates a flow diagram of one embodiment of a method of creating an image file representative of test pattern data for a display screen. As described above, an image may be created and saved in one or more graphics file formats and then subsequently displayed when that image file is read by graphics software. Beginning in block 400 a test pattern file may be opened by program code such as a script file written in any of a number of languages such as Perl, C or Unix, for example. Each bit in the test pattern file may be read (block 410). As each bit is read, the bit is checked to see if an end of pattern file marker has been read (block 420). If an end of file marker is encountered, then the test pattern file may be closed and an image file may be saved in one or more image file formats (block 460).

However, if an end of file marker is not encountered (block 420), the program code may determine what bit value it has read (block 430). The program code may compare each bit with a given set of bit values and subsequently determine a corresponding pixel attribute (block 440). As described above, a pixel attribute may be the color or the intensity of the pixel, for example. The program code may write the pixel attribute associated with the bit to the image file (block 450). For example, a script file may read in each bit as follows:

cat $1 | awk ‘{if ($1=“M”) print “250 0 0”; else print “0 0 250”;}’.

This piece of program code may check for don't care bits labeled ‘M’. If it finds an ‘M’ it causes a red pixel to be output. In a typical red green blue arrangement, [250 0 0] may correspond to a red pixel, [0 250 0] may correspond to a green pixel, [0 0 250] may correspond to a blue pixel. It is noted that the code segment shown above is only an example and that other code segments are contemplated and may be used.

The sequence described by blocks 410 through 450 may be repeated until an end of file marker is encountered and the image file may be saved as described in block 460.

Once the image file has been created, it may be displayed on a display screen such as display screen 300 of FIG. 3. As will be described further below, the resultant image may depict each of the bits in the device test pattern using a unique pixel on the display. These images may be used for various test pattern and test data analysis functions. For example, a test data image may be used to determine where a don't care value may be located in a particular test pattern. The image may also provide a visual indication of other test pattern issues such as whether scan input values have been captured or not. Further, the image may be used to highlight bits which are predominantly ones or zeros. In addition, bits may be sorted by data value instead of bit position in the pattern to give a visual indication of which bits have which state. These are only a few examples of the possible uses of image files generated as described above. Other uses of the images are possible and contemplated.

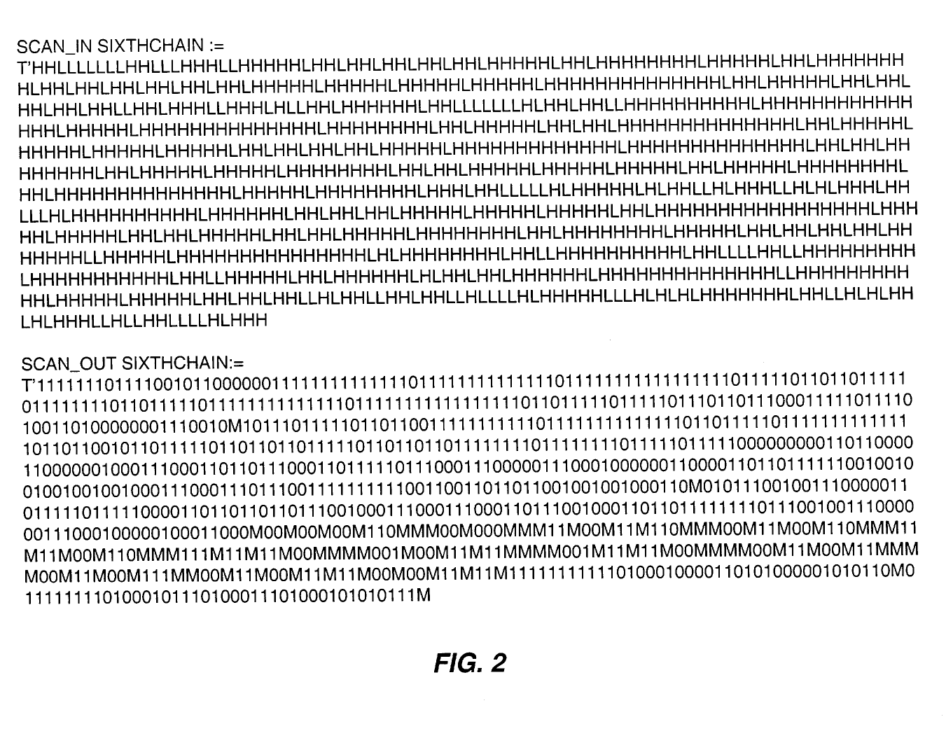

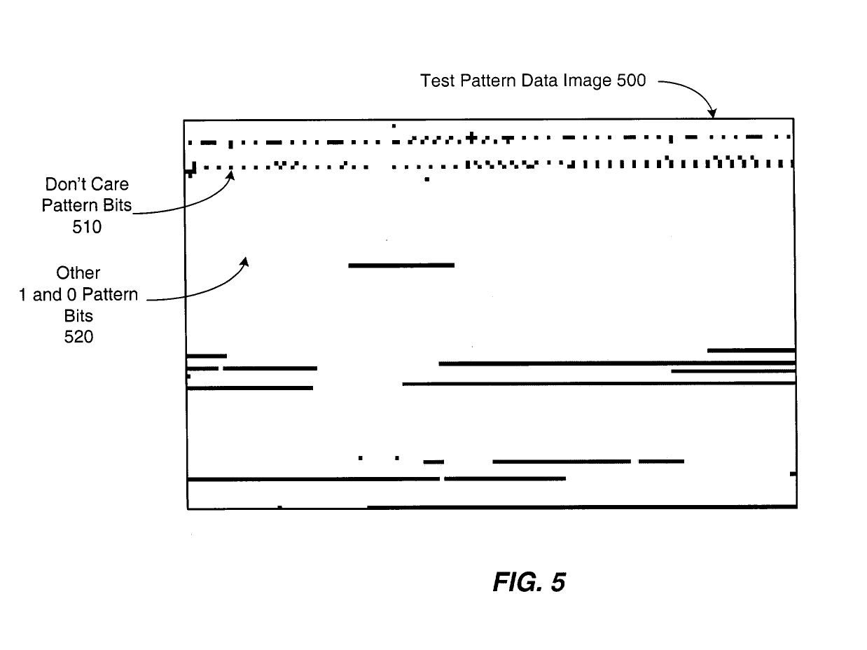

Turning to FIG. 5, one embodiment of an image corresponding to test pattern data is shown. A test pattern data image 500 is an image which depicts a test pattern data file. Each test pattern data bit within a test pattern such as the scan test pattern illustrated in FIG. 2, for example, is depicted as a unique pixel.

In the illustrated embodiment, test pattern data image 500 includes black and white pixels. The pattern bits which are “don't care” bits are depicted as black pixels and designated Don't Care Pattern Bits 510. All other pattern bits are depicted as white pixels and designated Other 1 and 0 Pattern Bits 520. It is noted however that in other embodiments, any color may be used to depict any bit in a test pattern.

Test pattern data image 500 may be viewed on a display such as display screen 300 of FIG. 3. Thus, a test pattern containing hundreds of thousands of bits may be displayed in one image which may be viewed in a single screen without having to scroll through the image. In addition, the image file may be printed and viewed at some other subsequent time.

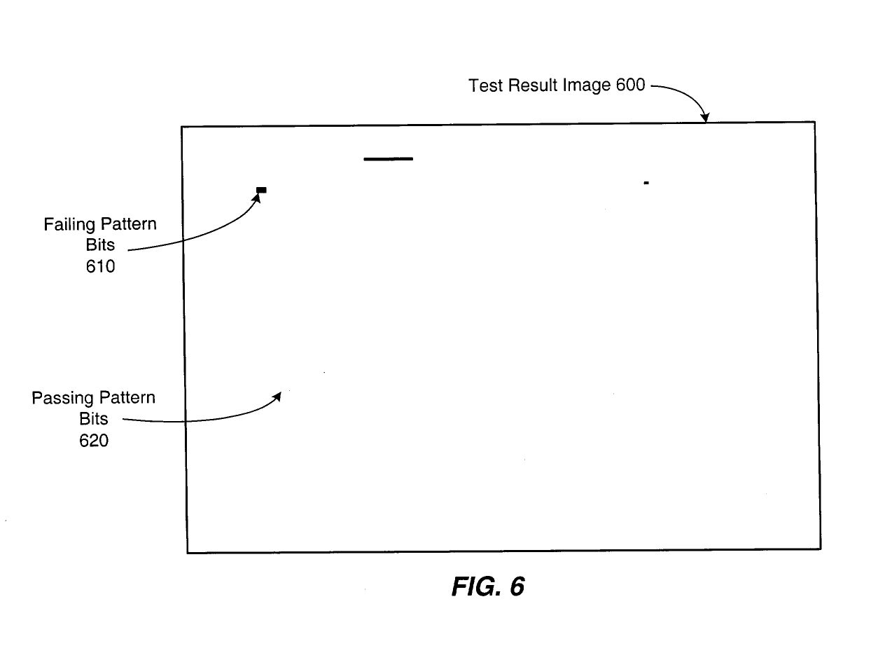

Referring to FIG. 6, one embodiment of an image corresponding to test result data is shown. Test result image data 600 is an image which depicts a test result data file such as a data log file. Each result data bit is depicted as a unique pixel. Test result image data 600 includes black and white pixels. The data log bits corresponding to passing pattern values are depicted using white pixels and designated Passing Pattern Bits 620. The data log bits corresponding to failing pattern values are depicted using black pixels and designated Failing Pattern Bits 610. It is noted that in other embodiments, other colors may be used for a given pixel. For example, data log bits corresponding to passing pattern values may be depicted using a pixel color such as green, while data log bits corresponding to failing pattern values may be depicted using a pixel color such as red.

Thus, by depicting each bit in a data log as a unique pixel on a display, a user may view hundreds of thousands of bits at a glance. This type of display may enhance failure analysis of a failing device.

For example, in one embodiment, each pixel may represent not only the type of data in the test pattern, but the pixel location may also be representative of the position of the data bit within a test sequence or scan chain. This in turn may give position or location information relative to the flip-flop or other storage element within the device. Thus the positions of particular values of the pattern data may create a signature when viewed as a graphic image.

It is noted that the above embodiments describe methods which may be implemented using program instructions. It is contemplated that various other embodiments may further include receiving, sending or storing instructions and/or data implemented in accordance with the above descriptions upon a carrier medium. Generally speaking, a carrier medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of displaying test data for a device, said method comprising:
receiving a test file, wherein said test file includes a plurality of bits; and
generating a graphic image representative of said test file by depicting each of said plurality of bits using a unique pixel of a display.

2. The method as recited in claim 1, wherein a visual attribute associated with each pixel is dependent upon a value associated with each of said plurality of bits.

3. The method as recited in claim 2, wherein said test file is a scan test pattern.

4. The method as recited in claim 2, wherein said visual attribute associated with each pixel is color.

5. The method as recited in claim 2, wherein said visual attribute associated with each pixel is brightness.

6. The method as recited in claim 2, wherein said value associated with each of said plurality of bits is an ASCII character representative of a binary value.

7. The method as recited in claim 2, wherein said value associated with each of said plurality of bits is an ASCII character representative of a don't care value.

8. The method as recited in claim 3, wherein each of said plurality of bits represents a state of a storage element within said device.

9. The method as recited in claim 8, wherein a position of a given pixel within said graphic image corresponds to a position of an associated one of said plurality of bits within said test file.

10. A system for displaying device test data comprising:
a processor configured to execute program instructions;
wherein said processor is further configured to read a test file including a plurality of bits;
a graphics adapter coupled to said processor and configured to generate a graphic image representative of said test file, wherein each of said plurality of bits is depicted as a unique pixel; and
a display coupled to said processor for displaying said graphic image.

11. The system as recited in claim 10, wherein a visual attribute associated with each pixel is dependent upon a value associated with each of said plurality of bits.

12. The system as recited in claim 11, wherein said test file is a scan test pattern.

13. The system as recited in claim 11, wherein a visual attribute associated with each pixel is color.

14. The system as recited in claim 11, wherein a visual attribute associated with each pixel is brightness.

15. The system as recited in claim 11, wherein said value associated with each of said plurality of bits is an ASCII character representative of a binary value.

16. The system as recited in claim 11, wherein said value associated with each of said plurality of bits is an ASCII character representative of a don't care value.

17. The system as recited in claim 12, wherein each of said plurality of bits represents a state of a storage element within said device.

18. The system as recited in claim 17, wherein a position of a given pixel within said graphic image corresponds to a position of an associated one of said plurality of bits within said test file.

19. A carrier medium comprising program instructions, wherein the program instructions are computer-executable to:
receive a device test file including a plurality of bits; and
generate a graphic image representative of said device test file by depicting each of said plurality of bits using a unique pixel of a display.

20. The carrier medium as recited in claim 19, wherein a visual attribute associated with each pixel is dependent upon a value associated with each of said plurality of bits.

21. The carrier medium as recited in claim 20, wherein said device test file is a scan test pattern.

22. The carrier medium as recited in claim 20, wherein a visual attribute associated with each pixel is color.

23. The carrier medium as recited in claim 20, wherein a visual attribute associated with each pixel is brightness.

24. The carrier medium as recited in claim 20, wherein said value associated with each of said plurality of bits is an ASCII character representative of a binary value.

25. The carrier medium as recited in claim 20, wherein said value associated with each of said plurality of bits is an ASCII character representative of a don't care value.

26. The carrier medium as recited in claim 21, wherein each of said plurality of bits represents a state of a storage element within said device.

27. The carrier medium as recited in claim 8, wherein a position of a given pixel within said graphic image corresponds to a position of an associated one of said plurality of bits within said test file.
